(19) United States
(12) Patent Application Publication
(10) Pub. No.: US 2010/0049666 A1
(43) Pub. Date: Feb. 25, 2010

(54) TRADING ANALYSIS TOOLS

(76) Inventor: James Tyler, London (GB)

Correspondence Address: BERENATO & WHITE, LLC, 6550 ROCK SPRING DRIVE, SUITE 240, BETHESDA, MD, 20817, US

(21) Appl. No.: 12/531,422

(22) PCT Filed: Mar. 11, 2008
(86) PCT No.: PCT/GB2008/000835

§ 371 Date: Sep. 15, 2009

(30) Foreign Application Priority Data
Mar. 15, 2007 (GB) 0705046.1

(51) Int. Cl. G06Q 40/00

(52) U.S. Cl. 705/36 R

(57) ABSTRACT

There is provided a method for analysing the trading results of a product by deriving a fair price for the product. The fair price is determined by analysing the best current bid price, the best current offer price, the quantity available for purchase at the best current bid price, the quantity available for sale at the best current offer price, the previous day's closing price and/or the minimum increment of price change as stipulated by an exchange on which the product is traded. The fair price derived for the product may be computed and used as a tool for analysing past or future trading results and for providing trading indications and guidelines.

### FIELD OF THE INVENTION

The invention relates to a method and apparatus for analysing the trading results of a product by deriving a fair price for the product.

### BACKGROUND OF THE INVENTION

This application relates to the trading of futures contracts and the provision of a useful tool for trading analysis. A futures contract is a standardised contract to buy or sell a certain underlying instrument at a certain date in the future at a specified price. A futures contract is a type of derivative.

The examples given in this application mainly relate to Short Term Interest Rate Futures (STIRs), although the tool could equally apply to any futures contract. Interest Rate Futures are exchange-traded forward rate agreements with standard contract sizes and maturity dates which are cash-settled on a daily basis throughout the life of the contract.

Short- and long-term interest rate futures contracts are traded on exchanges worldwide. Some of the more important short-term contracts traded on the Chicago Mercantile Exchange (CME) are the three-month Eurodollar (short-term, with unit of trading of US$ 1,000,000), the one-month LIBOR (short-term, with unit of trading of US$ 3,000,000), one year T-bills (short-term, with unit of trading of US$ 500,000), the three month Euroyen (short-term, with unit of trading of JPY 100,000,000) and 13-week US T-bills (short-term, with unit of trading of US$ 1,000,000—this contract is for physical delivery). Two long-term contracts traded on the CME are US T-bonds (nominal value US$ 100,000, maturity range at least 15 years) and 10 year US T-notes (nominal value US$ 100,000, maturity range between 6.5 and 10 year).

Some of the more important short-term contracts traded on the London International Financial Futures and Options Exchange (LIFFE) are the three-month Sterling LIBOR (known as Short Sterling, short-term, with unit of trading of GB£ 500,000), the three-month Euroswiss Franc (known as Euroswiss, short-term, with unit of trading of CHF 1,000,000), the three-month Euribor (short-term, with unit of trading of Euro 1,000,000) and the three-month Eurodollar (short-term, with unit of trading of US$ 1,000,000). Some long-term contracts traded on the LIFFE are Long Gilt (UK, nominal value GB [symbol] 50,000, maturity range between 10 and 15 years), Bund (German, Euros, maturity range between 8.5 and 10 years), JGB (Japanese, nominal value JPY 100,000,000, maturity ranged between 7 and 11 years) and the BTP (Italian, Euros, maturity range between 8 and 10.5 years).

Most of the examples given below will concern Short Sterling which is traded on the LIFFE. The unit of trading (i.e. the standard contract size) is GB [symbol] 500,000. The delivery months are March, June, September and December. The day the contract is settled (the Delivery Day) is the first business day after the last trading day. The last trading day i.e. the last day and time on which trading can take place, is 11.00 on the third Wednesday of the delivery month. The minimum price movement (this is the smallest amount a contract can change value—the tick size) is 0.01 i.e. [symbol] 12.50: 0.01 of the unit of trading is £50. This is divided into four three month periods (December to March, March to June, June to September, September to December) giving [symbol] 12.50 as the tick size. Alternatively, we could describe the Sterling tick as reflecting the value of a 1/100 of one percent change in a [symbol] 500,000, 90-day contract, i.e. 0.01%* [symbol] 500,000*90/360= [symbol] 12.50

Various terminology will be used throughout this description. For clarification, this will now be explained. Prices are separated into two categories: directional (outright) contracts and contiguous (spread) strategies. An outright is a single traded contract, for example the December 2008 Short Sterling contract. A strategy is a combination of outrights which fixes one outright against an exact inverse quantity of a second outright, for example the December 2008 March 2009 quarterly (3-month spread), which involves buying (+) one December outright and selling (−) one March outright. Other spread strategies include 6-month, 9-month and one-year spreads, or indeed any other combination of outrights. Further strategies are available. For example, butterflies (or ‘flies’) fix one spread against another spread, for example the December 2008 March 2009 spread against the March 2009 June 2009 spread. Other traded strategies include spread-of-flies (fixes one butterfly against another), fly-of-flies (fixes one spread-of-fly against another), packs (fixes one outright against the exact quantity (not inversed) of four consecutive outright contracts, made up of all four contracts in each twelve-month period e.g. −1 March 2008, −1 June 2008, −1 September 2008, −1 December 2008), bundles (made up of two or more packs in order, e.g. buy one of each of the first 8 (12 or 16 etc) outright contracts); strips (similar to a pack but for any amount of outright contracts), condors (fixes one outright against an exact inverse quantity of two second proceeding outrights and the exact (non-inverse) quantity of a fourth outright, e.g. +1 March 2008, −1 June 2008, −1 September 2008, +1 December 2008: this is like a fly across four contracts instead of three), and so on.

Another example of futures contracts to which the invention might be applied are futures contracts in the energy markets (including: crude oil, gasoline, heating oil, natural gas, coal and propane). Contracts here usually have one month gaps between contracts, and represent a single delivery of the underlying product. Other examples are commodities (‘softs’ such as meats, butter, orange juice, soybeans, grains, cocoa, coffee, sugar; metals such as gold, copper aluminium, zinc), foreign currencies (Euros, Dollars, Sterling, Yen, Swiss Franc etc), equities (stocks and shares), government and corporate bonds. Note that there are over 75 futures exchanges and hundreds of futures products.

With all financial instruments, but particularly those in which future dates are involved (so that the calculations become that much more complicated), analysis tools are useful for the traders so that profit and loss (both predicted and actual) and other trading results can be calculated.

### SUMMARY OF THE INVENTION

According to a first aspect of the invention, there is provided a method for analysing the trading results of a product by deriving a fair price for the product from the best current bid price for the product, the best current offer price for the product, the quantity of the product available for purchase at the best current bid price, the quantity of the product available for sale at the best current offer price, the previous day's closing price for the product and the minimum increment of price change for the product as stipulated by an exchange on which the product is traded, wherein: if there is no best current bid price and there is no best current offer price, the fair price is equal to the previous day's closing price, if there is no best current bid price, but there is a best current offer price, the strip price is equal to the lower of the best current offer price and the previous day's closing price, if there is no best current offer price, but there is a best current bid price, the strip price is equal to the larger of the best current bid price and the previous day's closing price, or if there is a best current offer price and a best current bid price: a) if the difference between the best current offer price and the best current bid price is one minimum increment, then the fair price is equal to the best current bid price plus a portion of the minimum increment, the portion being the quantity of the product available for purchase at the best current bid price as a fraction of the total quantity of the product available for sale and purchase at the best current offer price or bid price; or b) if the difference between the best current offer price and the best current bid price is two minimum increments, then the fair price is equal to the mean of the best current bid price and the best current offer price, or, if neither a) nor b) are satisfied, i) if the previous day's closing price is greater than the best current offer price, the fair price is equal to the best current offer price, or ii) if the previous day's closing price is less than the best current bid price, the fair price is equal to the best current bid price, or iii) if neither i) nor ii) are satisfied, the fair price is equal to the previous day's closing price.

The fair price derived for the product is not a price which can necessarily be traded but is simply a price which is used as a tool for analysing past or future trading results and for providing trading indications and guidelines.

According to a second aspect of the invention, there is provided a method of deriving a pricing curve for a plurality of futures contracts, each futures contact being associated with a maturity date, the method comprising the steps of: a) deriving the fair price for each of the plurality of futures contracts, according to the method of the first aspect of the invention; b) plotting the fair prices derived at step a) on a plot of price versus maturity date; and c) joining the points with a best-fit curve.

This method provides a pricing curve for outrights which can be used to calculate the strip price for each and every strategy type that it is possible to trade for that product.

According to a third aspect of the invention, part one, there is provided a method of deriving a pricing curve for a plurality of futures contracts, each futures contact being associated with a maturity date, the method comprising the steps of: a) deriving the fair price for one of the plurality of futures contracts, according to the method of claim 1; b) deriving the fair price for a spread of futures contracts, according to the method of claim 1, the spread being associated with two maturity dates, the first maturity date being the maturity date associated with the futures contract selected at step a); c) using the fair prices obtained at steps a) and b) to derive the fair price for a second of the plurality of futures contracts, the second of the plurality of futures contracts being associated with the second maturity date of the spread; d) repeating steps b) and c) for spreads contiguous with either the futures contract of step a) or the futures contract of step c); e) plotting the fair prices derived at steps a) and c) on a plot of price versus maturity date; and f) joining the points with a best-fit curve.

This method also provides a pricing curve of outrights which can be used to calculate each and every strategy type that it is possible to trade for that product.

There is also provided a method of trading comprising comparing a pricing curve derived from the second aspect of the invention with a pricing curve derived from the third aspect, part one of the invention.

In addition, according to the third aspect of the invention, part two, there is provided a method of deriving a pricing curve for a plurality of futures contract strategies, each futures contact strategy being associated with at least one maturity date, the method comprising the steps of: a) deriving the fair price for one of the plurality of futures contract strategies, according to the method of claim 1; b) deriving the fair price for a spread of futures contract strategies, according to the method of claim 1, the spread being associated with two maturity dates, the first maturity date being the at least one maturity date associated with the futures contract strategy selected at step a); c) using the fair prices obtained at steps a) and b) to derive the fair price for a second of the plurality of futures contract strategies, the second of the plurality of futures contract strategies being associated with at least the second maturity date of the spread; d) repeating steps b) and c) for spreads contiguous with either the futures contract strategy of step a) or the futures contract strategy of step c); e) plotting the fair prices derived at steps a) and c) on a plot of price versus maturity date; and f) joining the points with a best-fit curve.

This method provides a pricing curve of strategies (rather than outrights), which can also be used to calculate each and every strategy type that it is possible to trade for that product. The strategies could be any strategy, for example spreads, butterflies, spread-of-flies, fly-of-flies and so on.

According to a fourth aspect of the invention, part one, there is provided a method of deriving a fair price for a spread using two of the fair prices derived at step a) of the second aspect of the invention or the third aspect of the invention, part one, wherein:

spread^{ab}=outright^{a}−outright^{b}

wherein spread^{ab} refers to the fair price for the spread between a futures contract with maturity date a and a futures contract with maturity date b, outright^{a} refers to the fair price for the futures contract having a maturity date a and outright^{b} refers to the fair price for the futures contract having a maturity date b.

There is also provided a method of deriving a pricing chart for a plurality of futures contracts spreads comprising: a) performing the method of the fourth aspect of the invention, part one, for each of the plurality of futures contracts of the second aspect of the invention or the third aspect of the invention, part one; b) plotting the spread fair prices derived at step a) on a plot of price versus maturity date; and c) joining the points with a best-fit curve.

According to the fourth aspect of the invention, part two, there is provided a method of deriving a fair price for a strategy using the fair price derived at step a) of the third aspect of the invention, part two, and the fair price derived at step c) of the third aspect of the invention, part two, wherein:

strategy^{ab}=strategy^{a}−strategy^{b}

wherein strategy^{ab} refers to the fair price for the futures contract strategy between a futures contract strategy with maturity date a and a futures contract strategy with maturity date b, strategy^{a} refers to the fair price for the futures contract strategy having a maturity date a and strategy^{b} refers to the fair price for the futures contract strategy having a maturity date b.

There is also provided a method of deriving a pricing chart for a plurality of futures contracts strategies comprising: a) performing the method of the fourth aspect of the invention, part two, for each of the plurality of futures contract strategies of the third aspect of the invention, part two; b) plotting the strategy fair prices derived at step a) on a plot of price versus maturity date; and c) joining the points with a best-fit curve.

In one embodiment strategy^{ab}=butterfly^{a,b,c}, strategy^{a}=spread^{ab} and strategy^{b}=spread^{bc}.

In another embodiment, strategy^{ab}=fly-of-fly^{a,b,c,d,e}, strategy^{a}=butterfly^{a,b,c} and strategy^{b}=butterfly^{c,d,e}.

According to a fifth aspect of the invention, there is provided a method of deriving a cumulative profit or loss for a portfolio of products, using the fair price for each product derived according to the first aspect of the invention, the previous day's closing price for each product, the cumulative profit or loss of the portfolio as of the close of business on the previous day, net values for the position in each outright expiry date and the minimum increment of price change for each product as stipulated by the exchange, the method comprising the steps of: a) calculating the change in price for each product, wherein the change in price for a product is equal to: the fair price for the product minus the previous day's closing price for the product; b) calculating the fair profit or loss for each product, wherein the fair profit or loss for a product is equal to: the change in price for the product derived in step a), multiplied by the position of the product, multiplied by the minimum increment of price change for the product; c) summing the fair profit or loss for each product derived in step b) across all the products in the portfolio to give a portfolio fair profit or loss; d) calculating today's profit or loss for matched buys and sells, wherein today's profit or loss for matched buys and sells is equal to the absolute value of the difference between the matched purchase price and the matched sale price; e) calculating the portfolio profit or loss for the day, wherein the portfolio profit or loss for the day is equal to: the portfolio fair profit or loss derived in step c) plus today's profit or loss for matched buys and sells derived in step d); and f) calculating the cumulative profit or loss for the portfolio, wherein the cumulative profit or loss for the portfolio is equal to: the cumulative profit or loss of the portfolio as of the close of business on the previous day plus the portfolio profit or loss for the day derived in step e).

This derivation provides a true profit or loss for complicated portfolios that is not subject to old, misleading or non-existent last price data.

According to a sixth aspect of the invention, there is provided a method of providing an indication to a trader, the indication representing the likelihood that a submitted order to buy or sell a product will execute at a specified order price, the method comprising the steps of: a) continually calculating the fair price of the product according to the method of the first aspect of the invention, b) continually calculating the difference between the fair price of the product derived at step a) and the order price, in terms of the number of minimum increments of price change for the product; c) categorising the difference between the fair price and the order price as a risk category, depending on the value of the difference between the fair price and the order price in terms of the number of minimum increments of price change; and d) indicating the risk category to the trader.

Thus, the risk category, which simply represents how close the fair price is to the order price, and hence how likely the order is to execute at the order price, is indicated to the trader. This is extremely useful to the trader, especially when he has a number of different submitted orders at any one time.

The indication to the trader may be a visual indication or an oral indication. Preferably, the risk category is visually indicated to the trader on a trader user interface.

Preferably, each risk category is associated with a visual indication of a respective colour.

For example, the risk categories may be high, medium and low, with high risk associated with visual indication of the colour red, medium risk associated with a visual indication of the colour orange and low risk associated with a visual indication of the colour green.

According to a seventh aspect of the invention, there is provided a method of providing an indication to a trader that a profit-making opportunity might be available, the method comprising the steps of: a) continually calculating the fair price of a plurality of futures contract strategies according to the method of claim 1, each futures contract strategy being associated with at least one maturity date; b) using at least two of the futures contract strategies fair prices calculated at step a) to continually derive the fair price of a futures contract strategy related to the at least two futures contract strategies of step a); c) continually comparing the strategy fair price derived at step b) with the best current bid price for the strategy of step b) and the best current offer price for the strategy of step b), and d) if the strategy fair price derived at step b) is higher than the best current offer price for the strategy of step b) or lower than the best current bid price for the strategy of step b), providing an indication to the trader.

Preferably, the indication to the trader is a visual indication on a trader user interface.

There is also provided apparatus specially adapted to carry out the method of any of the aspects of the invention.

There is also provided a computer program which, when run on computer means, causes the computer means to carry out the method of any of the aspects of the invention. There is also provided a record carrier having stored thereon such a computer program.

Features described in relation to one aspect of the invention may also be applicable to other aspects of the invention.

### BRIEF DESCRIPTION OF THE DRAWINGS

FIG. 1 shows a method of calculating a Strip Price in accordance with a first embodiment of the invention;

FIG. 2 shows a benchmark outright pricing curve derived from the Strip Price of FIG. 1;

FIG. 3 shows an alternative benchmark outright pricing curve derived from the Strip Price of FIG. 1;

FIG. 4 shows a general strategy pricing curve derived from the Strip Price of FIG. 1;

FIG. 5 shows a method of calculating today's cumulative net equity for a portfolio of products from the Strip Prices of FIG. 1;

FIG. 6 shows a method for indicating to a trader the likelihood that an already submitted trade will execute, based on the difference between the Strip Price of FIG. 1 and the order price; and

FIG. 7 shows a method of indicating to a trader a potential profit-making opportunity.

### DETAILED DESCRIPTION OF PREFERRED EMBODIMENTS

A first embodiment of the invention will now be described. The inventors have found that producing a Strip Price, which is a “fair value” price for a single product or strategy (e.g. an outright, spread, butterfly or condor of a specified product type) is an extremely useful trading analysis tool and is a more straightforward and accurate way to predict profit and loss. The Strip Price can be calculated for any openly traded product that has a bid/offer spread.

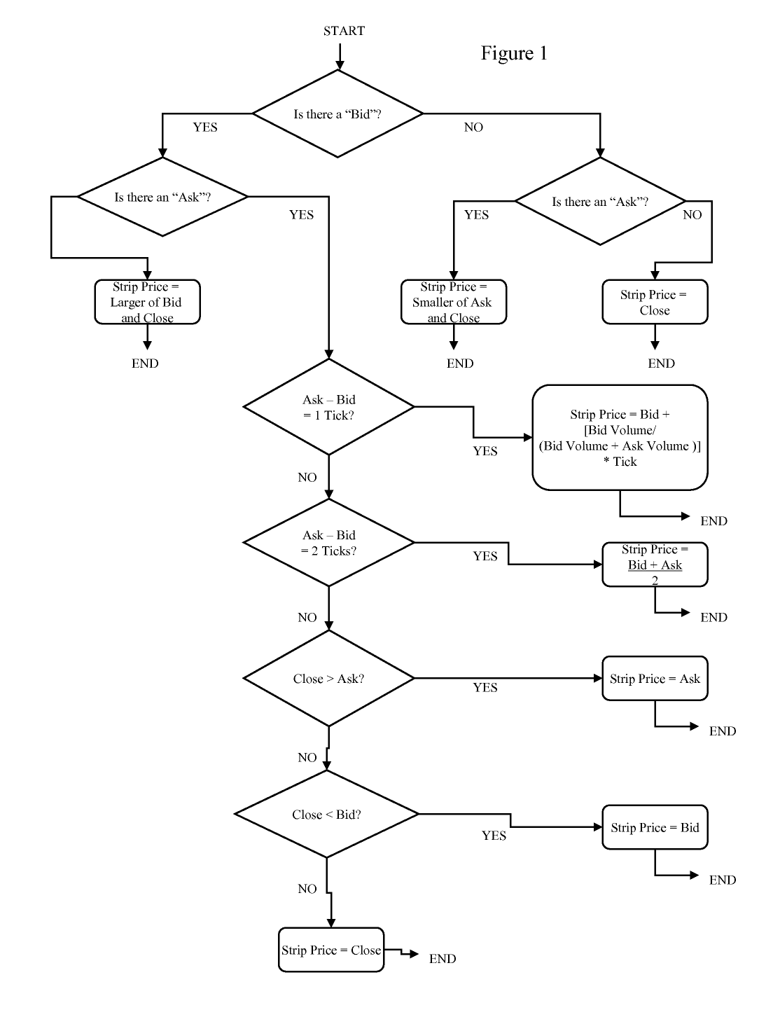

According to a first embodiment of the invention, the Strip Price is calculated as shown in FIG. 1. This is as follows.

The first step is to obtain the necessary inputs. Those are “Bid”, “Ask”, “Bid Volume”, “Ask Volume”, “Close” and “Tick”. “Bid” is the best, i.e. highest, bid price (purchase price) currently in the market for a specified product, or the highest price at which a seller can sell immediately. “Ask” is the best, i.e. lowest, ask price (sale price) currently in the market for the product, or the lowest price at which a buyer can buy immediately. “Bid Volume” is the quantity available for purchase at the Bid. “Ask Volume” is the quantity available for sale at the Ask. “Close” is the previous day's closing price as determined by the exchange. “Tick” is the minimum price increment as specified by the exchange.

Note that, not every exchange actually uses whole ticks as the minimum price movement; some work on half ticks or even quarter ticks. However, in this specification, the term “Tick” is used to indicate the minimum price movement as stipulated by the relevant exchange. This may not have the same meaning as the term tick used by the exchange.

The second step is to calculate the Strip Price from those inputs. The general idea is to find a price between the Bid and the Ask, that is based on the volume available for sale and/or purchase and represents a fair price. The calculation comprises:

1) If there is no Bid and there is no Ask, then: Strip Price=Close.
2) If there is no Bid, but there is an Ask, then
a) if Ask<Close, then: Strip Price=Ask
   or b) if Ask≧Close, then: Strip Price=Close
   (or, putting it another way, if there is no Bid, choose the smaller of the Ask and the Close as the Strip Price).
   3) If there is no Ask, but there is a Bid, then
a) if Bid>Close, then: Strip Price=Bid
   or b) if Bid≦Close, then: Strip Price=Close
   (or, putting it another way, if there is no Ask, choose the larger of the Bid and the Close as the Strip Price).
   4) If there is both an Ask and a Bid, then:
a) if Ask−Bid=1 Tick, then:

Strip Price=Bid+[Bid Volume/(Bid Volume+Ask Volume)]*Tick

(or, putting it another way, find a Strip Price that is between the Ask and the Bid by an amount which depends on the Bid Volume as a proportion of the total volume of Asks and Bids)
or b) if Ask−Bid=2 Ticks, then:

Strip Price=(Bid+Ask)/2

(or, putting it another way, find a Strip Price that is halfway between the bid and the Ask i.e. the mean of the Bid and the Ask)
or c) if Close>Ask, then: Strip Price=Ask
or d) if Close<Bid, then: Strip Price=Bid
otherwise e) Strip Price=Close.

Thus, the Strip Price, which is a fair price for the particular product of interest, is calculated. Note that the Strip Price is not a real price, in the sense that the product cannot necessarily be traded at that price. However, the Strip Price is an accurate way to give an idea of profit and loss, amongst other uses, and so is a very useful tool for the trader. Using fractions of a tick means that you have a price which cannot necessarily be used for trading but is representative of the current state of the market and can be used as a trading analysis tool.

The inventors have found that the Strip Price can be used as a tool in a number of different ways, a selection of which will now be described.

The first way of using the Strip Price calculated above is to create a simple pricing curve of outright prices, which can be used to calculate the strip prices for each and every strategy type (outrights, strips, packs, bundles, spreads, butterflies, condors and so on) that it is possible to trade, either directly at the exchange or by a process of trading individual legs at the exchange.

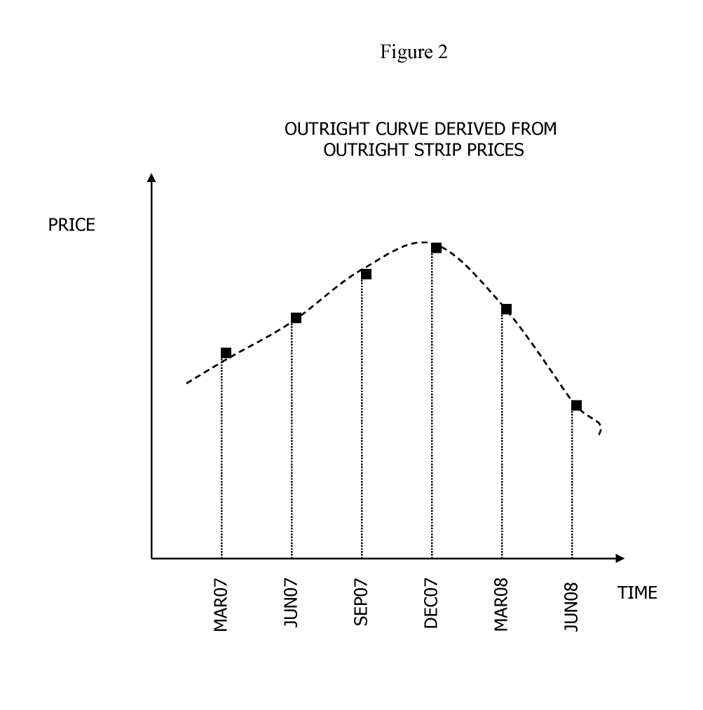

Firstly, we calculate the Strip Price for each available outright price. Then, we plot those points on a graph of price (y-axis) versus time (x-axis). Such a graph is shown in FIG. 2, which uses as an example, Short Sterling contracts from March 2007 through June 2008.

The use of the plot to determine prices for other strategies will be described below.

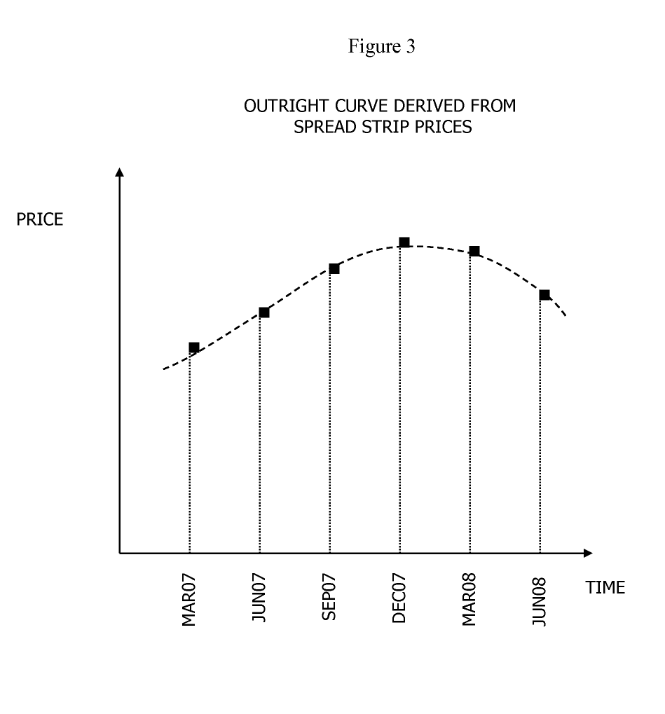

The second way of using the Strip Price calculated above is to derive a benchmark pricing curve using spreads of outrights, rather than the outrights themselves. This can be used to calculate the strip price of each and every strategy type, whether traded directly at the exchange or by trading individual legs at the exchange. This is shown in FIG. 3. For example, we can use the Strip Price derived for a Short Sterling contract (e.g. March 2007) to derive the Strip Prices for contiguous later (e.g. March 2007 June 2007) or contiguous earlier (December 2006 March 2007) 3-month Short Sterling spreads.

Such a spread curve is not necessarily better than the straightforward outright curve, but it provides additional useful information to a trader. The trader makes a judgement which curve or data he wishes to use, but, of course, where the curves agree, then it provides a stronger trade signal. For example, the curves of FIGS. 2 and 3 generally agree for March 2007, June 2007, September 2007 and December 2007 but begin to diverge for 2008.

Firstly, we select the most active outright maturity. This can be either the most highly traded contact, in terms of volume, (most likely) or can simply be any selected contract. In this example, we select the March Short Sterling contract.

Then, we use the calculation above, to calculate the current Strip Price for that outright maturity. So, in this example, we obtain a current Strip Price for the March Short Sterling outright.

Then, we select spreads that are contiguous with the selected outright maturity. So, in this example we could look at the December March Short Sterling spread (i.e. the preceding spread) and/or at the March June Short Sterling spread (i.e. the next spread). For each of those spreads we calculate the current Strip Price.

Once we have those values, we can obtain the Strip Prices of the adjacent outrights, from the Strip Prices of the intervening spreads. For example, from the March outright Strip Price and the March June spread Strip Price, we calculate the June outright Strip Price. We continue to do this for further adjacent outrights. Once we have a number of values calculated by that method, we plot the obtained outright Strip Prices on a plot of price (y-axis) versus contract maturity (x-axis).

Now consider an example of Short Sterling contracts. The most active outright maturity is found to be March 2007. For that contract, the “Bid” is 9609, the “Ask” is 9610, the “Bid Volume” is 500 and the “Ask Volume” is 500. This gives us a Strip Price of 9609.5. The March June spread has a “Bid” of 13, an “Ask” of 14, a “Bid Volume” of 100 and an “Ask Volume” of 100. This gives us a Strip Price of 13.5. From these two values, we can obtain the June 2007 outright Strip Price: 9609.5−13.5=9596. This process is then repeated using the next contiguous spread, and so on.

In the example given in this application of the Strip Price and in the simple outright curve application of the Strip Price, we have referred to Short Sterling Interest Rate Futures. However, the tool is equally applicable to any futures contract which has a maturity date associated with it.

We have also used the shortest time periods for the outright i.e. for the example 3-month contracts. For example, for Brent crude, we would use 1 month time periods. However, we could, of course use longer time periods (e.g. 6, 9 or 12 month contracts for Sterling) but this would provide a less accurate best-fit curve.

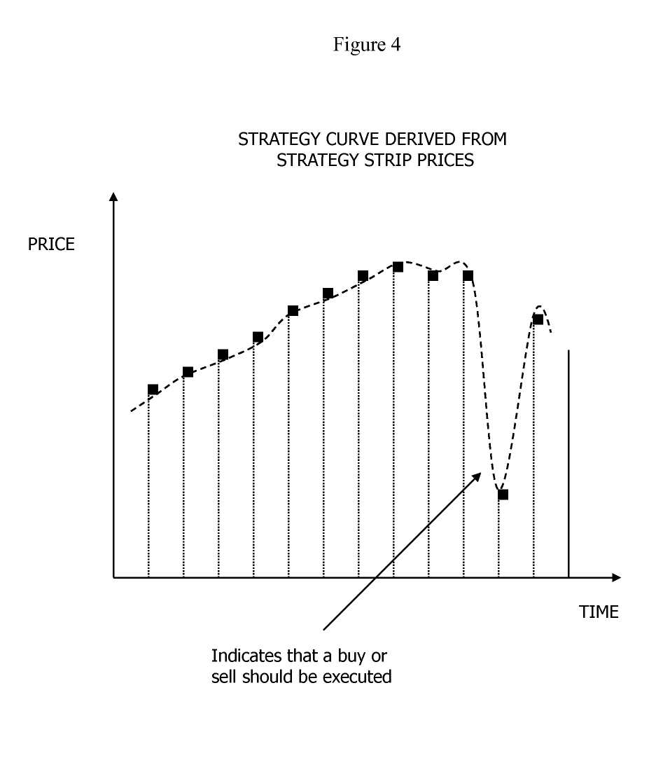

In the first application (FIG. 2), we plotted graph of outright price generated from outright strip prices and, in the second application (FIG. 3), we plotted a graph of outright price generated from spread strip prices. Of course, we could plot graphs of the Strip Prices of other strategies e.g. butterflies, spread-of-flies and so on. This will be described further below in relation to FIG. 4. And, of course, we could plot graphs of outrights using other strategies to generate the outright points.

Once the benchmark curve points (either for outrights or for a strategy e.g. a spread) has been calculated, the benchmark curve can be used to calculate fair prices for other strategies of the same product type. For example, to obtain the Strip Price for a 9-month spread, the Strip Price for the ending outright would be obtained and then subtracted from the outright price at the start of the spread.

This is done as follows:

The first step is to obtain the required outright expiry dates for the strategy. For example, we want to derive the price for the 9-month spread of March 2008 December 2008.

Then, we can use the following formulae, to obtain the required price:

spread^{ab}=outright^{a}−outright^{b}

wherein spread^{ab} refers to the Strip Price for the spread between maturity date a and maturity date b, outright^{a} refers to the Strip Price for the outright having a maturity date a and outright^{b} refers to the Strip Price for the outright having a maturity date b.

In our example, the Strip Price for the 9-month spread of March 2008 December 2008 would be the Strip Price for the Short Sterling March 2008 contract minus the Strip Price for the short Sterling December 2008 contract.

From this formula, further strategies, can be calculated. For example:

$$\begin{matrix}{Butterfly}^{a , b , c} = {spread}^{ab} - {spread}^{bc} \\ = {outright}^{a} - {outright}^{b} - [ {outright}^{b} - {outright}^{c} ] \\ = {outright}^{a} - 2 ⋆ {outright}^{b} + {outright}^{c}\end{matrix}$$

We can also use the following formulae:

condor^{a,b,c,d}=outright^{a}−outright^{b}−outright^{c}−outright^{d}

pack^{a,b,c,d}=outright^{a}+outright^{b}+outright^{c}+outright^{d}

Another application of the Strip Price that will now be described is the Strip Price based Butterfly and Fly-of-Fly pricing charts. In this application, we derive pricing charts for the strategies of a particular outright, using the formulae given above. Any of the strategies can have pricing curves generated using the Strip Price but, as a rule, the Butterfly Pricing Chart and the Fly-of-Fly Pricing Charts are the most useful.

For the Butterfly Pricing Chart, the steps are as follows:

1) Obtain Strip Prices for each outright expiration date t e.g. strip prices for June delivery Short Sterling, September delivery Short Sterling and December delivery Short Sterling.
2) For each outright expiration date t, calculate a Butterfly Strip Price (according to the formulae above) as follows:

$$\begin{matrix}{Butterfly}^{a , b , c} = {spread}^{ab} - {spread}^{bc} \\ = {outright}^{a} - {outright}^{b} - [ {outright}^{b} - {outright}^{c} ] \\ = {outright}^{a} - 2 ⋆ {outright}^{b} + {outright}^{c}\end{matrix}$$

e.g. Butterfly Strip Price for Short Sterling June, September, December=Short Sterling Strip Price for June−2*(Short Sterling Strip Price for September)+Short Sterling Strip Price for December.
3) Plot each Butterfly Strip Price on a graph of expiry date (x-axis) versus price (y-axis).

Similarly, for the Fly-of-Fly Pricing Chart, the steps are as follows:

1) Obtain Strip Prices for each butterfly expiration date t.
2) For each outright expiration date t, calculate a Fly of Fly Strip Price (according to the formulae above) as follows:

Fly-of-Fly^{a,b,c,d,e}=outright^{a}−4*outright^{b}+6*outright^{c}−4*outright^{d}+outright^{e}

A visual representation is extremely useful to the trader because the shape of the curve can give him important clues about trades to execute. An example of a strategy curve is shown in FIG. 4. For example, if there is a spike in the curve, this is an indication to the trader that something is out of line and that a buy or sell trade should be executed. This type of trading relies on the concept of “revision to the mean” i.e. a bet that over time the curve will flatten out where it has kinks.

One principle is to produce a visual representation of the strategy which is the double time differential of the product being traded i.e. for trading outrights, a butterfly pricing chart is produced, for trading butterflies, a fly-of-fly pricing chart is produced, for trading spreads, a spread-of-fly pricing chart is produced.

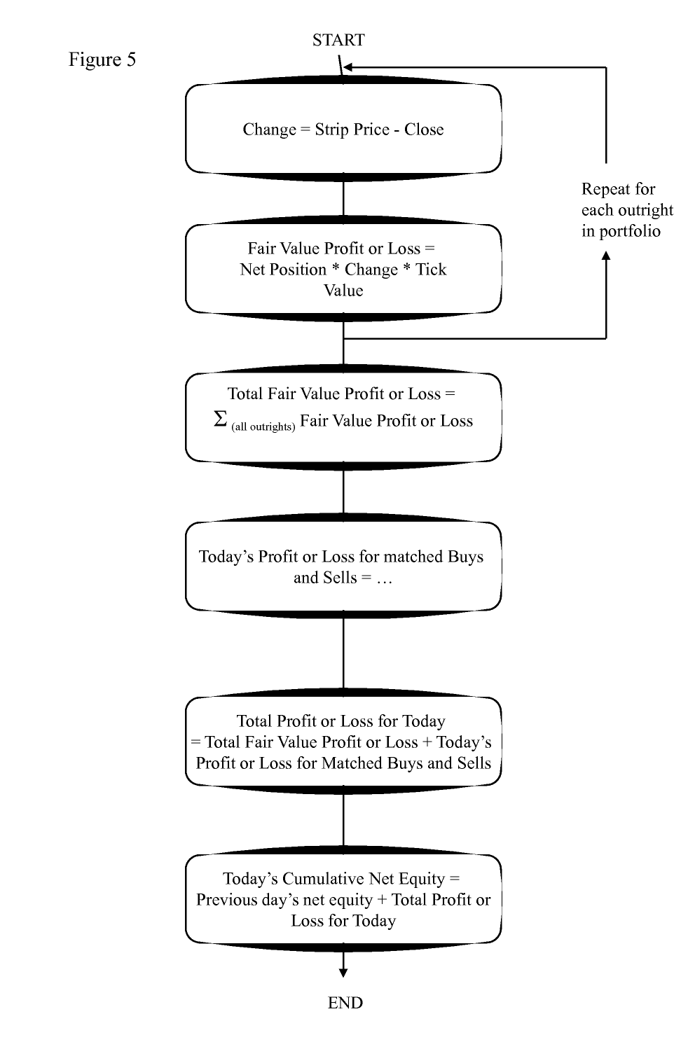

Another application of the Strip Price is the Strip Price based Profit/Loss Calculation. This is shown in FIG. 5. This calculation provides a profit or loss calculation based on a fraction-of-a-tick price, rather than a discrete last price. The advantage of this is that it gives a true determination of profit or loss for complicated portfolios, which is not affected by old, misleading or non-existent last price data.

The portfolios of interest will comprise a number of different outrights. In the simplified example referred to below, we consider a Short-Sterling type portfolio, for example comprising the four three-month contracts for a particular year, plus the two 6-month contracts and one 9-month contract. Of course, portfolios can be considerably more complicated including many different contracts and maturity dates. However complex a portfolio, it can always be broken down into its lowest common denominators—the underlying outrights.

The first step is to obtain the necessary inputs. Those are “Closes”, “Previous day's Net Equity”, “Strip Prices”, “Positions” and “Tick Value”. “Closes” are previous day's closing prices, for the various outrights in the portfolio, as provided by the exchange. “Previous day's Net Equity” is the cumulative profit or loss of the portfolio as of the close of business on the previous day, based on the Closes. “Strip Prices” are the strip prices, calculated as described above, for each outright expiry date. “Positions” are a list of net values for the position in each outright expiry date e.g. if a contract is bought but not sold (or vice-versa) the result will be a net open position. For example, if I buy 100 March June spreads and I sell 100 June September spreads, I am left with an open position of +100 March, −200 June and +100 September. To turn these figures into a numeric value for our calculations, we multiply 100 by the price for the March outright, 200 by the price for the June outright and 100 by the price for the September outright and add/minus them appropriately. “Tick Value” is the monetary value assigned to the minimum tick fluctuation (e.g. for Short Sterling, this would be GB£ 12.50).

The second step is to calculate today's Fair Value Profit or Loss for each individual outright expiry date's position. Firstly, we calculate the Change:

Change=Strip Price−Close

Secondly, we calculate the Profit or Loss:

Fair Value Profit or Loss=Net Position*Change*Tick Value

Thus, in the Short-Sterling example, we will have a Fair Value Profit or Loss derived for each outright in the portfolio.

The third step is to sum each individual Fair Value Profit or Loss to give a total Fair Value Profit or Loss for the portfolio i.e.

Total Fair Value Profit or Loss=Σ_{(over all outrights)} Fair Value Profit or Loss

The fourth step is to calculate today's Profit or Loss for Matched Buys and Sells. That is, for those sales or purchases that are agreed (i.e. matched), we calculate the profit or loss we have made. This is simply the difference between the matched purchase price and matched sale price (or vice versa) since the position is no longer open.

The fifth step is to calculate the Total Profit or Loss for the Day, as follows:

Total Profit or Loss for the Day=Today's Total Fair Value Profit or Loss+Today's Profit or Loss for Matched Buys and Sells

The sixth and final step is to calculate Today's Cumulative Net Equity i.e. the cumulative profit or loss of the portfolio as of today, as follows:

Today's Cumulative Net Equity=Previous Day's Net Equity+Total Profit or Loss for Today

Thus, we obtain today's cumulative net equity i.e. cumulative profit or loss of the portfolio as of today. This cumulative net equity calculation is based on the fair price (fraction-of-a-tick price) so is not subject to old, misleading or non-existent last price data.

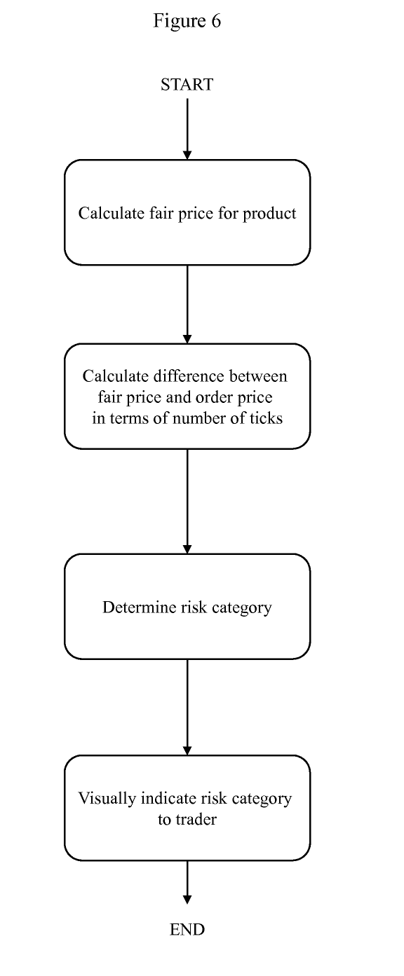

Another application of the Strip Price is the Strip Price Based order Risk Evaluation. This is shown in FIG. 6. This application of the Strip Price is for a trade order that has been submitted by a trader but has not yet been executed at the exchange (“filled”). The Strip Price is compared to the order price and the result is used as a measure of the likelihood that the order will execute at the current time. A visual indication is passed to the trader to show the likelihood of the submitted order executing. This application can be used for any product type and is particularly suited to those products which can be traded on an electronic exchange.

The first step is to obtain the necessary inputs. Those are the strategy type (e.g. Short Sterling), details of the submitted order (in particular the Order Price), the warning ratios (low risk, medium risk, high risk and very high risk)—calculation of these will be described below, the tick value and, optionally, the warning colours and bar lengths—these can be selected and will be described below.

The warning ratio is simply the difference between the Order Price and the Strip Price as a proportion of one tick. The particular warning ratios can be selected. For example, Low Risk=warning ratio≧½ tick, Medium Risk=¼ tick≦warning ratio<½ tick, High Risk=0.1 tick≦warning ratio<¼ tick, Very High Risk=warning ratio≦0.1 tick.

The warning colours and bar lengths are simply ways of visually indicating the data to a trader. The warning colours are simply those colours that will appear on the screen (against the particular order) when the warning ratio is of a particular risk. For example, Low Risk=green, Medium Risk=yellow, High Risk=orange, Very High Risk=red. The bar lengths simply specify which cells on the trader's screen are to be coloured. For example, a bar might appear against the order in question, short at Low Risk, increasing to maximum at Very High Risk.

Once these have been chosen, the trader's screen will provide a visual indication of the risk of the submitted order executing. For example, if the warning ratio is Low Risk, price data is coloured green. If the warning ratio is Medium Risk, price data is coloured yellow. If the warning ratio is High Risk, price data is coloured orange. If the warning ratio is Very High Risk, price data is coloured red. Clearly, other visual indications might be used e.g. flashing, lights. Or, indeed, sound may be used e.g. a continuous sound pulse for Low Risk, increasing in rate until it is a continuous sound for Very High Risk.

Whilst this calculation is somewhat subjective—actually, a contract will only trade when the opposite trade enters the market—this nonetheless provides a degree of likelihood of the trade executing.

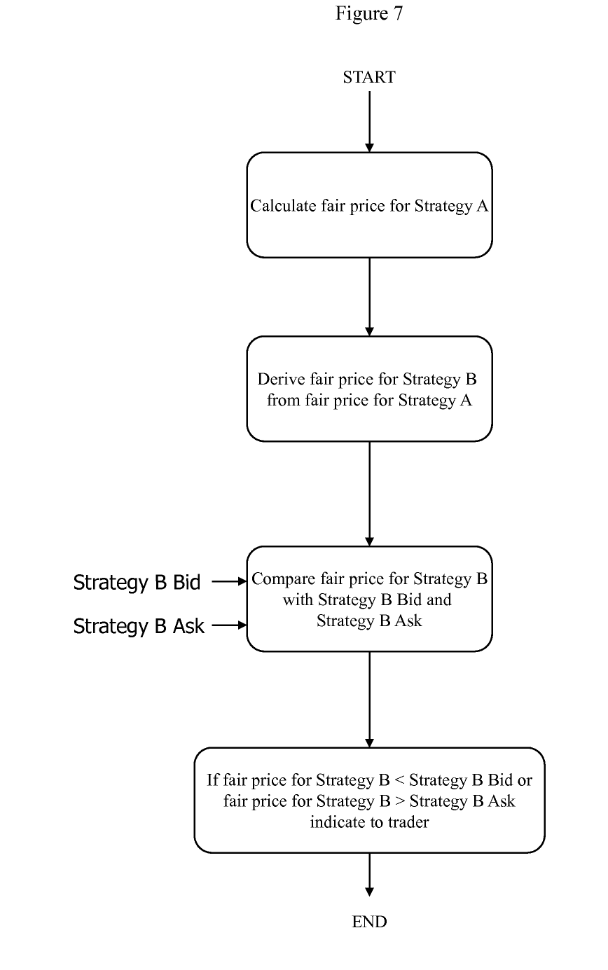

A final application of the Strip Price will now be described with reference to FIG. 7. If the Strip Price for an outright (or indeed any strategy type) is calculated and then used to calculate the Strip Price for another strategy type (e.g. a spread contiguous with the original outright), the resulting strategy Strip Price may be found to be outside the bid-offer range i.e. either above the Ask or below the Bid. Obviously this will not happen if the Strip Price for the strategy is calculated directly from the same strategy figures (rather than the outright figures or another strategy) and it sounds counter-intuitive. The idea here is that you use one set of data to imply strip prices in another. When the strip prices are out of the range of the latter bid/offer spreads, it needs highlighting as an opportunity—effectively the market is ‘out of line’.

For example, if the strategy Strip Price is below the Bid, theoretically, it should be possible to immediately sell at the Bid price and then immediately buy back at the cheaper Strip Price. Similarly, if the strategy Strip Price is above the Ask, it should theoretically be possible to immediately buy at the Ask price and then sell at the dearer Strip Price. In either case, it implies a possible profit-making opportunity.

To make use of this, a visual indication is provided to the trader whenever the Strip Price of the strategy, as calculated from the original strategy, is outside the bid-offer range. This could be a flashing indication on the user interface by the contract in question.

The last two applications could easily be combined on a trader's trading interface. For example, the trader may be trading a number of contracts. On some of those contracts, he might already have placed an order, which has not yet been filled, in which case an appropriate coloured and sized bar might be shown adjacent the order. On some of those contracts, he may not have placed an order. From time to time, against those contracts, an indication might appear to indicate that, if the trader places an order now, he could make a profit.

In addition, all the various applications could, of course, be combined.

1. A method for analysing the trading results of a product by deriving a fair price for the product from the best current bid price for the product, the best current offer price for the product, the quantity of the product available for purchase at the best current bid price, the quantity of the product available for sale at the best current offer price, the previous day's closing price for the product and the minimum increment of price change for the product as stipulated by an exchange on which the product is traded, wherein:
if there is no best current bid price and there is no best current offer price, the fair price is equal to the previous day's closing price,
if there is no best current bid price, but there is a best current offer price, the strip price is equal to the lower of the best current offer price and the previous day's closing price,
if there is no best current offer price, but there is a best current bid price, the strip price is equal to the larger of the best current bid price and the previous day's closing price, or
if there is a best current offer price and a best current bid price:
a) if the difference between the best current offer price and the best current bid price is one minimum increment, then the fair price is equal to the best current bid price plus a portion of the minimum increment, the portion being the quantity of the product available for purchase at the best current bid price as a fraction of the total quantity of the product available for sale and purchase at the best current offer price or bid price;
or b) if the difference between the best current offer price and the best current bid price is two minimum increments, then the fair price is equal to the mean of the best current bid price and the best current offer price,
or, if neither a) nor b) are satisfied, i) if the previous day's closing price is greater than the best current offer price, the fair price is equal to the best current offer price, or ii) if the previous day's closing price is less than the best current bid price, the fair price is equal to the best current bid price, or iii) if neither i) nor ii) are satisfied, the fair price is equal to the previous day's closing price.

2. A method of deriving a pricing curve for a plurality of futures contracts, each futures contract being associated with a maturity date, the method comprising the steps of:
a) deriving the fair price for each of the plurality of futures contracts, according to the method of claim 1;
b) plotting the fair prices derived at step a) on a plot of price versus maturity date; and
c) joining the points with a best-fit curve.

3. A method of deriving a pricing curve for a plurality of futures contracts, each futures contact being associated with a maturity date, the method comprising the steps of:
a) deriving the fair price for one of the plurality of futures contracts, according to the method of claim 1;
b) deriving the fair price for a spread of futures contracts, according to the method of claim 1, the spread being associated with two maturity dates, the first maturity date being the maturity date associated with the futures contract selected at step a);
c) using the fair prices obtained at steps a) and b) to derive the fair price for a second of the plurality of futures contracts, the second of the plurality of futures contracts being associated with the second maturity date of the spread;
d) repeating steps b) and c) for spreads contiguous with either the futures contract of step a) or the futures contract of step c);
e) plotting the fair prices derived at steps a) and c) on a plot of price versus maturity date; and
f) joining the points with a best-fit curve.

4. A method of deriving a pricing curve for a plurality of futures contract strategies, each futures contract strategy being associated with at least one maturity date, the method comprising the steps of:
a) deriving the fair price for one of the plurality of futures contract strategies, according to the method of claim 1;
b) deriving the fair price for a spread of futures contract strategies, according to the method of claim 1, the spread being associated with two maturity dates, the first maturity date being the at least one maturity date associated with the futures contract strategy selected at step a);
c) using the fair prices obtained at steps a) and b) to derive the fair price for a second of the plurality of futures contract strategies, the second of the plurality of futures contract strategies being associated with at least the second maturity date of the spread;
d) repeating steps b) and c) for spreads contiguous with either the futures contract strategy of step a) or the futures contract strategy of step c);
e) plotting the fair prices derived at steps a) and c) on a plot of price versus maturity date; and
f) joining the points with a best-fit curve.

5. A method of deriving a fair price for a spread using two of the fair prices derived at step a) of claim 2, wherein:
spread^{ab}=outright^{a}−outright^{b}
wherein spread^{ab} refers to the fair price for the spread between a futures contract with maturity date a and a futures contract with maturity date b, outright^{a} refers to the fair price for the futures contract having a maturity date a and outright^{b} refers to the fair price for the futures contract having a maturity date b.

6. A method of deriving a pricing chart for a plurality of futures contracts spreads comprising:
a) performing the method of claim 5 for each of a plurality of futures contracts;
b) plotting the spread fair prices derived at step a) on a plot of price versus maturity date; and
c) joining the points with a best-fit curve.

7. A method of deriving a fair price for a spread using the fair price derived at step a) of claim 3 and the fair price derived at step c) of claim 3, wherein:
spread^{ab}=outright^{a}−outright^{b}
wherein spread^{ab} refers to the fair price for the spread between a futures contract with maturity date a and a futures contract with maturity date b, outright^{a} refers to the fair price for the futures contract having a maturity date a and outright^{b} refers to the fair price for the futures contract having a maturity date b.

8. A method of deriving a pricing chart for a plurality of futures contracts spreads comprising:
a) performing the method of claim 7 for each of a plurality of futures contracts;
b) plotting the spread fair prices derived at step a) on a plot of price versus maturity date; and
c) joining the points with a best-fit curve.

9. A method of deriving a fair price for a strategy using the fair price derived at step a) of claim 4 and the fair price derived at step c) of claim 4, wherein:
strategy^{ab}=strategy^{a}−strategy^{b}
wherein strategy^{ab} refers to the fair price for the futures contract strategy between a futures contract strategy with maturity date a and a futures contract strategy with maturity date b, strategy^{a} refers to the fair price for the futures contract strategy having a maturity date a and strategy^{b} refers to the fair price for the futures contract strategy having a maturity date b.

10. A method of deriving a pricing chart for a plurality of futures contracts strategies comprising:
a) performing the method of claim 9 for each of a plurality of futures contract strategies;
b) plotting the strategy fair prices derived at step a) on a plot of price versus maturity date; and
c) joining the points with a best-fit curve.

11. A method according to claim 10, wherein strategy^{ab}=butterfly^{a,b,c}, strategy^{a}=spread^{ab} and strategy^{b}=spread^{bc}.

12. A method according to claim 10, wherein strategy^{ab}=fly-of-fly^{a,b,c,d,e}, strategy^{a}=butterfly^{a,b,c} and strategy^{b}=butterfly^{c,d,e}.

13. A method of deriving a cumulative profit or loss for a portfolio of products, using the fair price for each product derived according to the method of claim 1, the previous day's closing price for each product, the cumulative profit or loss of the portfolio as of the close of business on the previous day, net values for the position in each outright expiry date and the minimum increment of price change for each product as stipulated by the exchange, the method comprising the steps of:
a) calculating the change in price for each product, wherein the change in price for a product is equal to: the fair price for the product minus the previous day's closing price for the product;
b) calculating the fair profit or loss for each product, wherein the fair profit or loss for a product is equal to: the change in price for the product derived in step a), multiplied by the position of the product, multiplied by the minimum increment of price change for the product;
c) summing the fair profit or loss for each product derived in step b) across all the products in the portfolio to give a portfolio fair profit or loss;
d) calculating today's profit or loss for matched buys and sells, wherein today's profit or loss for matched buys and sells is equal to the absolute value of the difference between the matched purchase price and the matched sale price;
e) calculating the portfolio profit or loss for the day, wherein the portfolio profit or loss for the day is equal to: the portfolio fair profit or loss derived in step c) plus today's profit or loss for matched buys and sells derived in step d); and
f) calculating the cumulative profit or loss for the portfolio, wherein the cumulative profit or loss for the portfolio is equal to: the cumulative profit or loss of the portfolio as of the close of business on the previous day plus the portfolio profit or loss for the day derived in step e).

14. A method of providing an indication to a trader, the indication representing the likelihood that a submitted order to buy or sell a product will execute at a specified order price, the method comprising the steps of:
a) continually calculating the fair price of the product according to the method of claim 1,
b) continually calculating the difference between the fair price of the product derived at step a) and the order price, in terms of the number of minimum increments of price change for the product;
c) categorising the difference between the fair price and the order price as a risk category, depending on the value of the difference between the fair price and the order price in terms of the number of minimum increments of price change; and
d) indicating the risk category to the trader.

15. A method according to claim 14, wherein the risk category is visually indicated to the trader on a trader user interface.

16. A method according to claim 15, wherein each risk category is associated with a visual indication of a respective colour.

17. A method of providing an indication to a trader that a profit-making opportunity might be available, the method comprising the steps of:
a) continually calculating the fair price of a plurality of futures contract strategies according to the method of claim 1, each futures contract strategy being associated with at least one maturity date;
b) using at least two of the futures contract strategies fair prices calculated at step a) to continually derive the fair price of a futures contract strategy related to the at least two futures contract strategies of step a);
c) continually comparing the strategy fair price derived at step b) with the best current bid price for the strategy of step b) and the best current offer price for the strategy of step b); and
d) if the strategy fair price derived at step b) is higher than the best current offer price for the strategy of step b) or lower than the best current bid price for the strategy of step b), providing an indication to the trader.

18. A method according to claim 17, wherein the indication to the trader is a visual indication on a trader user interface.

19. Apparatus specially adapted to carry out the method of claim 1.

20. A computer program which, when run on computer means, causes the computer means to carry out the method of claim 1.

21. A record carrier having stored thereon a computer program according to claim 20.
